(19) United States
(12) Patent Application Publication
(10) Pub. No.: US 2008/0151261 A1
(43) Pub. Date: Jun. 26, 2008

(54) Process and apparatus for online detection of surface irregularity in threadlines

(76) Inventor: Jon Jacob Kaminer, Richmond, VA (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(21) Appl. No.: 11/642,157

(22) Filed: Dec. 20, 2006

(51) Int. Cl. G01N 21/47

(52) U.S. Cl. 356/600

(57) ABSTRACT

The invention concerns a process and apparatus for monitoring the level of surface irregularity in a moving threadline, comprising: (a) illuminating the threadline via a light source positioned incident to the thread line at an entrance angle of greater than 0 degrees and less than 90 degrees to the threadline to produce spectral reflectance energy and diffuse reflectance energy; (b) measuring the amount of spectral reflectance energy from the threadline with a first receiver positioned incident to the threadline at an exit angle that is substantially equal to the entrance angle; (c) measuring the amount of diffuse reflectance energy from the threadline with a second receiver positioned at an angle that is different than the entrance angle and the exit angle, (d) determining the ratio of the amount of diffuse reflectance energy to the amount of spectral reflectance energy; and (e) relating said ratio to the level of surface irregularity.

### FIELD OF THE INVENTION

The present invention concerns a process for the online detection of surface irregularities in threadlines.

### BACKGROUND OF THE INVENTION

Threadlines are subject to surface irregularities that negatively impact the quality of the threadline. In some instances, the filaments of a threadline are subject to fibrillation during manufacture and processing. Fibrillation is often more severe in rigid rod polymers. U.S. Pat. Nos. 5,030,841; 4,948,260; and 4,563,095 were directed to the detection of various attributes of materials using light sources. There is a need in the art, however, for an improved process and apparatus for monitoring surface irregularities such as fibrillation.

### SUMMARY OF THE INVENTION

In some embodiments, the invention concerns a process for monitoring the level of surface irregularity in a moving threadline, comprising:

illuminating the threadline via a light source positioned incident to the threadline at an entrance angle of greater than 0 degrees and less than 90 degrees to the threadline to produce spectral reflectance energy and diffuse reflectance energy; measuring the amount of spectral reflectance energy from the threadline with a first receiver positioned incident to the threadline at an exit angle that is substantially equal to the entrance angle;

measuring the amount of diffuse reflectance energy from the threadline with a second receiver positioned at an angle different than the entrance angle and the exit angle, determining the ratio of the amount of diffuse reflectance energy to the amount of spectral reflectance energy; and

relating said ratio to the level of surface irregularity.

In certain embodiments, the invention relates to processes and apparatus for monitoring the level of filament fibrillation in a moving threadline by the methods and apparatus described herein.

In some embodiments, the threadline is a single filament threadline. In other embodiments, the threadline is a multifilament threadline.

The second receiver can be placed at any position where diffuse light can be detected. In some embodiments, the second receiver is placed between the light source and the first receiver. In some embodiments, the second receiver is positioned at an angle of 60 degrees to 120 degrees to the threadline. In certain embodiments, the second receiver is positioned at an angle that is substantially 90 degrees to the threadline.

In some embodiments, the entrance angle is 30 to 60 degrees to the threadline. In certain embodiments, the entrance angle is essentially 45 degrees to the threadline.

Some preferred threadlines comprise rigid rod filaments. Suitable rigid rod filaments include those comprising aramid polymer. Some aramid polymers are para-aramids such as poly(p-phenylene terephthalamide).

Other suitable polymers include poly[2,6-diimidazo[4,5-b:4,5-e]-pyridinylene-1,4(2,5-dihydroxy)phenylene, polybenzoxazole and polybenzothiazole.

In some threadlines, the surface is irregular because of filament fibrillation. In certain embodiments, the filament fibrillation is 1-3 microns in diameter. Some filament fibrillation is up to 4 mm in length.

In some embodiments, the process is performed on a threadline that is in the production process. In other embodiments, the process is performed post-production of the threadline.

In some embodiments, the invention concerns an apparatus for monitoring the level of surface irregularity in a moving threadline, comprising;

a light source positioned incident to the thread line at an entrance angle of greater than 0 degrees and less than 90 degrees to the threadline, the light source producing spectral reflective energy and diffuse reflective energy;

a first receiver for receiving spectral reflectance energy of the light source from the threadline, the first receiver positioned incident to the threadline at an exit angle substantially equal to the entrance angle;

a second receiver for receiving diffuse reflectance energy of the light source from the threadline, the second receiver positioned incident to the threadline at an angle that is different than the entrance angle and the exit angle; and

a comparator for determining the ratio of the amount of diffuse reflective energy to the amount of spectral reflective energy.

In some embodiments, the first and second receivers are positioned at the end of first and second channels, such that light passes through the channels prior to contacting the detectors.

In some embodiments, the light source is positioned at the end of a channel, such that the light passes through the channel prior to contacting the threadline.

In certain embodiments, some or all of the channels are in communication with a gas purge stream. In some embodiments, the gas is air. In other embodiments, the gas is nitrogen or another inert gas. The gas stream can be positioned to keep the light source, detectors, and/or apertures free of dust and debris.

### BRIEF DESCRIPTION OF THE DRAWINGS

FIG. 1 illustrates the detection process using one embodiment of the detection apparatus.

FIG. 2 shows the diffuse reflectance of damaged yarn and better yarn in a dark room and a lighted room. In addition, the spectral reflectance of damaged yarn and better yarn in a dark room is shown.

### DETAILED DESCRIPTION OF ILLUSTRATIVE EMBODIMENTS

The present invention may be understood more readily by reference to the following detailed description of illustrative and preferred embodiments that form a part of this disclosure. It is to be understood that the scope of the claims is not limited to the specific devices, methods, conditions or parameters described and/or shown herein, and that the terminology used herein is for the purpose of describing particular embodiments by way of example only and is not intended to be limiting of the claimed invention. Also, as used in the specification including the appended claims, the singular forms “a,” “an,” and “the” include the plural, and reference to a particular numerical value includes at least that particular value, unless the context clearly dictates otherwise. When a range of values is expressed, another embodiment includes from the one particular value and/or to the other particular value. Similarly, when values are expressed as approximations, by use of the antecedent “about,” it will be understood that the particular value forms another embodiment. All ranges are inclusive and combinable.

Light shining on the smooth surface of smooth or undamaged filaments give primarily mirror-like “spectral” reflectance which comes off the surface at the same exit angle as the entrance angle. This light can be captured by a sensor placed at the appropriate location in line with the ray reflected at the entrance angle. When the illuminating light hits a rough surface (i.e., a surface irregularity such as that caused by a fibrillation damage), a higher percentage of the light is scattered at ‘random angles’. This “diffuse” reflectance can be captured by a sensor positioned at an angle other than the “spectral” angle. By measuring the amount of diffuse reflectance, the amount of surface irregularity can be inferred. By measuring the ratio of diffuse to spectral reflectance, this inference can be made independent of the source strength. This can be especially advantageous in an on-line sensor.

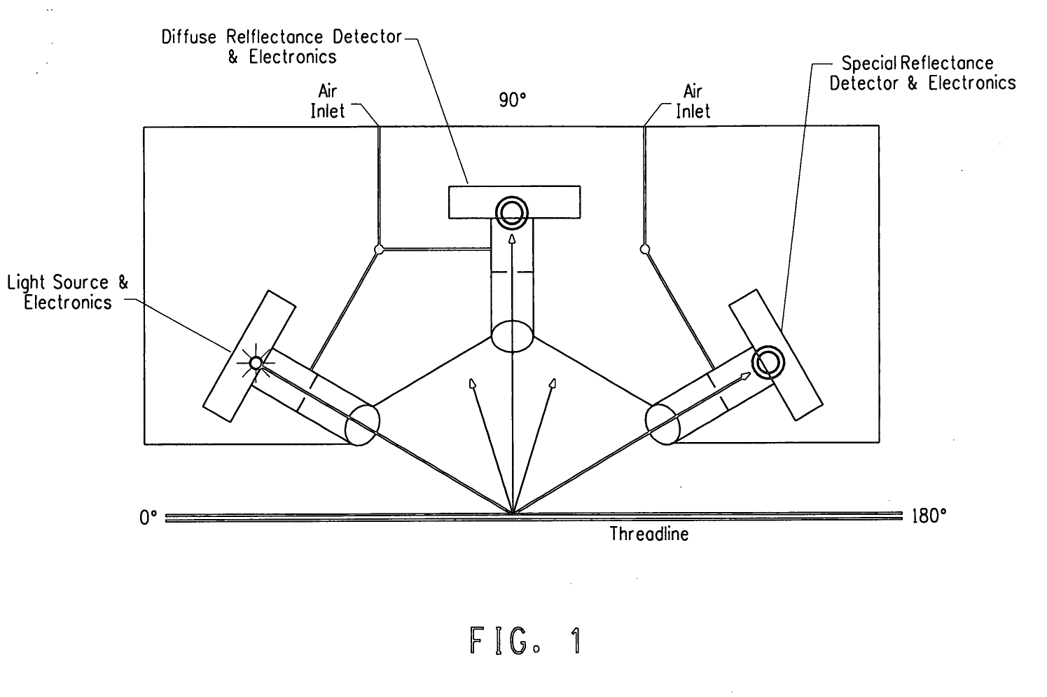

In one embodiment, the detectors can be placed at the end of a channel remote from the filament. FIG. 1 shows one potential enclosure for this scheme. The light source and the two detectors are each at the end of separate small channels and the end of the channel having the light source or detector is referred to herein as the electronic end of the channel. Each channel of ‘dead air’ provides some protection from potential contamination. The length and diameter of the channel provide some additional light focusing, particularly if the sides are absorbing.

To further focus the beam, and to further protect the elements and critical path from contamination that could non-uniformly block light, one or both of the following may be employed:
an aperture near the electronic end of the channel, and/or
a pure gas purge stream (such as instrument air) entering near the electronic, keeping a constant stream of clean gas blowing thru the channel, and the aperture if present.

With these measures, contamination at the open end of the channel would need to be very significant to block the path of light that would normally reach the aperture. The gas stream keeps the aperture clear, and also prevents major contamination at the open end. Such measures can greatly reduce the impact of contamination present in the monitoring area.

The process can use white light with no entrance or receiver filters. In some embodiments, however, color filters can be utilized. The light does not have to be limited to visible light; other specific wavelengths in the spectrum could be used. Further, the use of polarized light and polarized detectors could be used.

The receivers used in the present invention comprise a means for detecting the intensity of light that come in contact with the receiver.

As used herein, a comparator is a circuit for comparing two signals. Such devices are well known to those skilled in the art. In some embodiments, the comparator is used for determining the ratio of the amount of diffuse reflective energy to the amount of spectral reflective energy. The ratio can be determined from signals produced from the first and second receivers in response to the amount (or intensity) of reflected light the receiver detects. In certain embodiments, the comparator can optionally relate the value obtained from the comparison of the two receivers with a standard value (such as obtained from known samples) and produce an indicator of yarn quality or surface irregularity.

Examples of suitable fibers included those that have fibrillatable filaments. Such fibers include those made from rigid-rod polymers and include types of polybenzazoles; aramids, such as poly(paraphenylene terephthalamide) sold by E. I. du Pont de Nemours and Company (DuPont), Wilmington, Del. under the trade name KEVLAR®; and polypyridazoles, such as the polypyridobisimidazole known under the trade name M5®. In some embodiments, the tenacity of a fiber should be at least about 900 MPa according to ASTM D-885 in order to provide superior ballistic penetration resistance. In some embodiments, the fiber preferably also has a modulus of at least about 10 GPa.

In one embodiment, when the polymer is polyamide, aramid is preferred. By “aramid” is meant a polyamide wherein at least 85% of the amide (—CO—NH—) linkages are attached directly to two aromatic rings. Suitable aramid fibers are described in Man-Made Fibers-Science and Technology, Volume 2, Section titled Fiber-Forming Aromatic Polyamides, page 297, W. Black et al., Interscience Publishers, 1968. Aramid fibers are, also, disclosed in U.S. Pat. Nos. 4,172,938; 3,869,429; 3,819,587; 3,673,143; 3,354,127; and 3,094,511. Additives can be used with the aramid and it has been found that up to as much as 10 percent, by weight, of other polymeric material can be blended with the aramid or that copolymers can be used having as much as 10 percent of other diamine substituted for the diamine of the aramid or as much as 10 percent of other diacid chloride substituted for the diacid chloride or the aramid.

One preferred aramid is a para-aramid and poly(p-phenylene terephthalamide)(PPD-T) is the preferred para-aramid. By PPD-T is meant the homopolymer resulting from approximately mole-for-mole polymerization of p-phenylene diamine and terephthaloyl chloride and, also, copolymers resulting from incorporation of small amounts of other diamines with the p-phenylene diamine and of small amounts of other diacid chlorides with the terephthaloyl chloride. As a general rule, other diamines and other diacid chlorides can be used in amounts up to as much as about 10 mole percent of the p-phenylene diamine or the terephthaloyl chloride, or perhaps slightly higher, provided only that the other diamines and diacid chlorides have no reactive groups which interfere with the polymerization reaction. PPD-T, also, means copolymers resulting from incorporation of other aromatic diamines and other aromatic diacid chlorides such as, for example, 2,6-naphthaloyl chloride or chloro- or dichloroterephthaloyl chloride or 3,4′-diaminodiphenylether.

Polyareneazole polymers, such as polybenzazoles and polypyridazoles, can be made by reacting a mix of dry ingredients with a polyphosphoric acid (PPA) solution. The dry ingredients may comprise azole-forming monomers and metal powders. Accurately weighed batches of these dry ingredients can be obtained through employment of at least some of the preferred embodiments of the present invention.

Exemplary azole-forming monomers include 2,5-dimercapto-p-phenylene diamine, terephthalic acid, bis-(4-benzoic acid), oxy-bis-(4-benzoic acid), 2,5-dihydroxyterephthalic acid, isophthalic acid, 2,5-pyridodicarboxylic acid, 2,6-napthalenedicarboxylic acid, 2,6-quinolinedicarboxylic acid, 2,6-bis(4-carboxyphenyl)pyridobisimidazole, 2,3,5,6-tetraaminopyridine, 4,6-diaminoresorcinol, 2,5-diaminohydroquinone, 1,4-diamino-2,5-dithiobenzene, or any combination thereof. Preferably, the azole forming monomers include 2,3,5,6-tetraaminopyridine and 2,5-dihydroxyterephthalic acid. In certain embodiments, it is preferred that that the azole-forming monomers are phosphorylated. Preferably, phosphorylated azole-forming monomers are polymerized in the presence of polyphosphoric acid and a metal catalyst.

Metal powders can be employed to help build the molecular weight of the final polymer. The metal powders typically include iron powder, tin powder, vanadium powder, chromium powder, and any combination thereof.

The azole-forming monomers and metal powders are mixed and then the mixture is reacted with polyphosphoric acid to form a polyareneazole polymer solution. Additional phosphoric acid can be added to the polymer solution if desired. The polymer solution is typically extruded or spun through a die or spinneret to prepare or spin

Polybenzoxazole (PBO) and polybenzothiazole (PBZ) are two suitable polybenzazole polymers. These polymers are described in PCT Application No. WO 93/20400. Polybenzoxazole and polybenzothiazole are preferably made up of repetitive lowing structures:

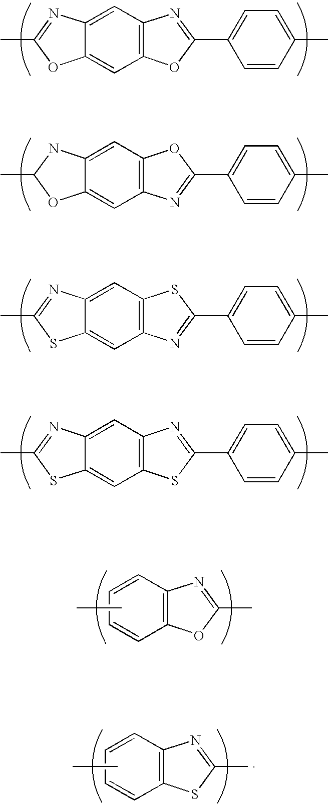

While the aromatic groups shown joined to the nitrogen atoms may be heterocyclic, they are preferably carbocyclic; and while they may be fused or unfused polycyclic systems, they are preferably single six-membered rings. While the group shown in the main chain of the bis-azoles is the preferred para-phenylene group, that group may be replaced by any divalent organic group which doesn't interfere with preparation of the polymer, or no group at all. For example, that group may be aliphatic up to twelve carbon atoms, tolylene, biphenylene, bis-phenylene ether, and the like.

The polybenzoxazole and polybenzothiazole used to make fibers of this invention should have at least 25 and preferably at least 100 repetitive units. Preparation of the polymers and spinning of those polymers is disclosed in the aforementioned PCT Patent Application No. WO 93/20400.

Fibers made from poly(pyridazole) polymers are suitable for use in the present invention. These polymers include poly(pyridimidazle), poly(pyridothiazole), poly(pyridoxazole), poly(pyridobisimidazole), poly(pyridobisthiazole), and poly(pyridobisoxazole).

Poly(pyridobisimidazole) is a rigid rod polymer that is of high strength. The poly(pyridobisimidazole) fiber can have an inherent viscosity of at least 20 dl/g or at least 25 dl/g or at least 28 dl/g. Such fibers include PIPD fiber (also known as M5® fiber and fiber made from poly[2,6-diimidazo[4,5-b:4,5-e]-pyridinylene-1,4(2,5-dihydroxy)phenylene). PIPD fiber is based on the structure:

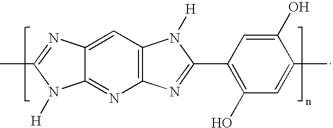

PIPD fibers have been reported to have the potential to have an average modulus of about 310 GPa (2100 grams/denier) and an average tenacities of up to about 5.8 GPa (39.6 grams/denier). These fibers have been described by Brew, et al., Composites Science and Technology 1999, 59, 1109; Van der Jagt and Beukers, Polymer 1999, 40,1035; Sikkema, Polymer 1998, 39, 5981; Klop and Lammers, Polymer, 1998, 39, 5987; Hageman, et al., Polymer 1999, 40, 1313.

For purposes herein, the term “fiber” is defined as a relatively flexible, macroscopically homogeneous body having a high ratio of length to width across its cross-sectional area perpendicular to its length. The fiber cross section can be any shape, but is typically round. Herein, the term “filament” or “continuous filament” is used interchangeably with the term “fiber.”“Threadline”, as used herein, encompasses monofilament and multifilament threadlines.

The term “multifilament threadline” refers to a plurality of filaments that are associated with each other. Such threadlines are well known to those skilled in the art. The filaments may be twisted or otherwise associated with each other in the absence of twisting.

### EXAMPLES

The invention is illustrated by, but is not intended to be limited by the following examples.

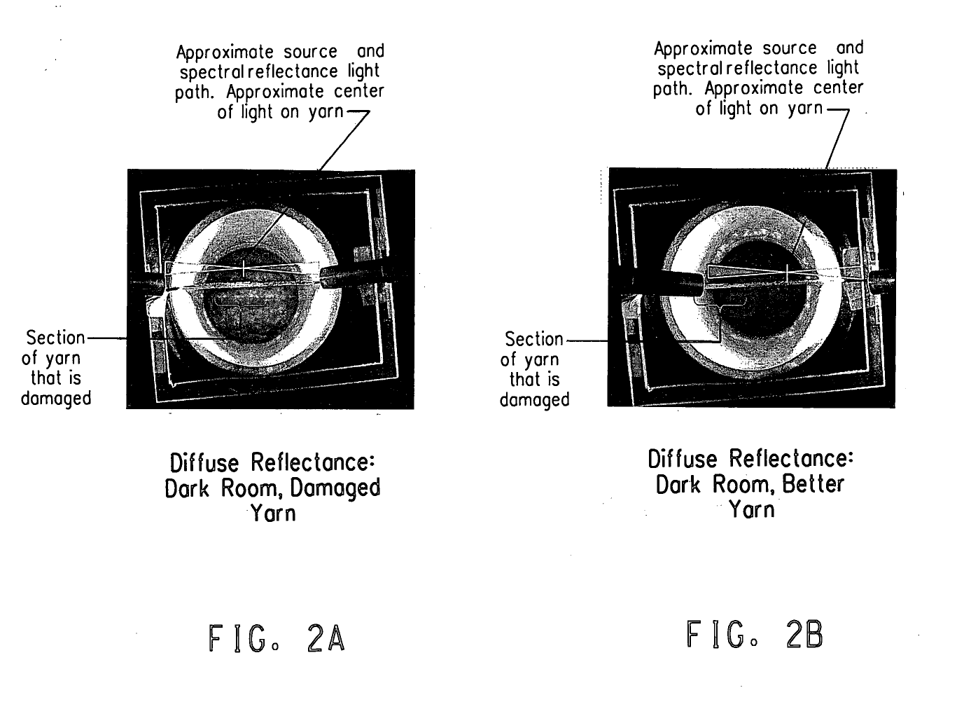

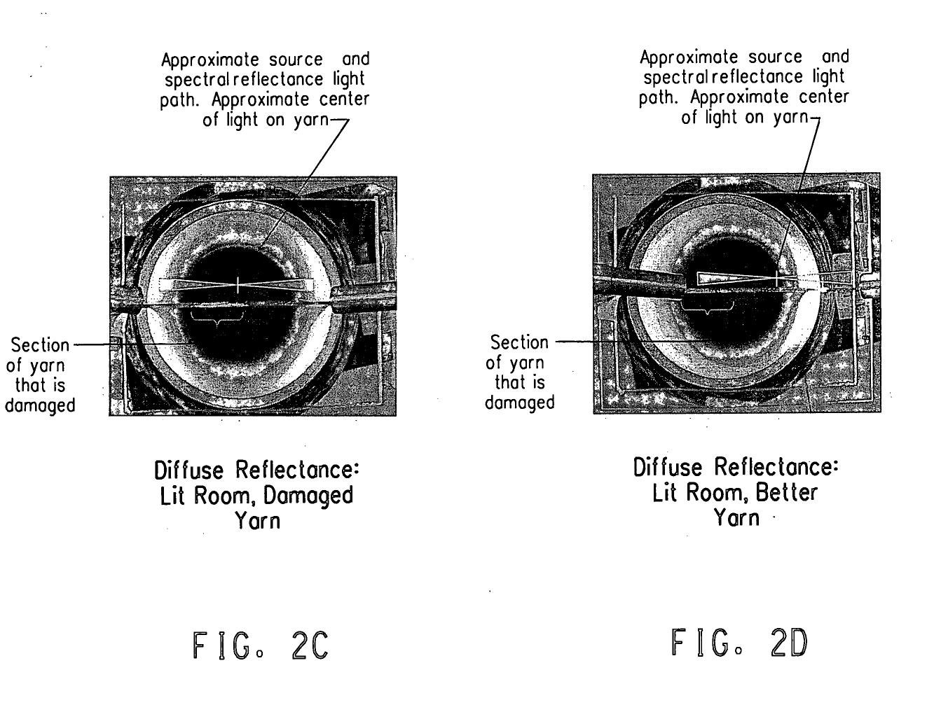

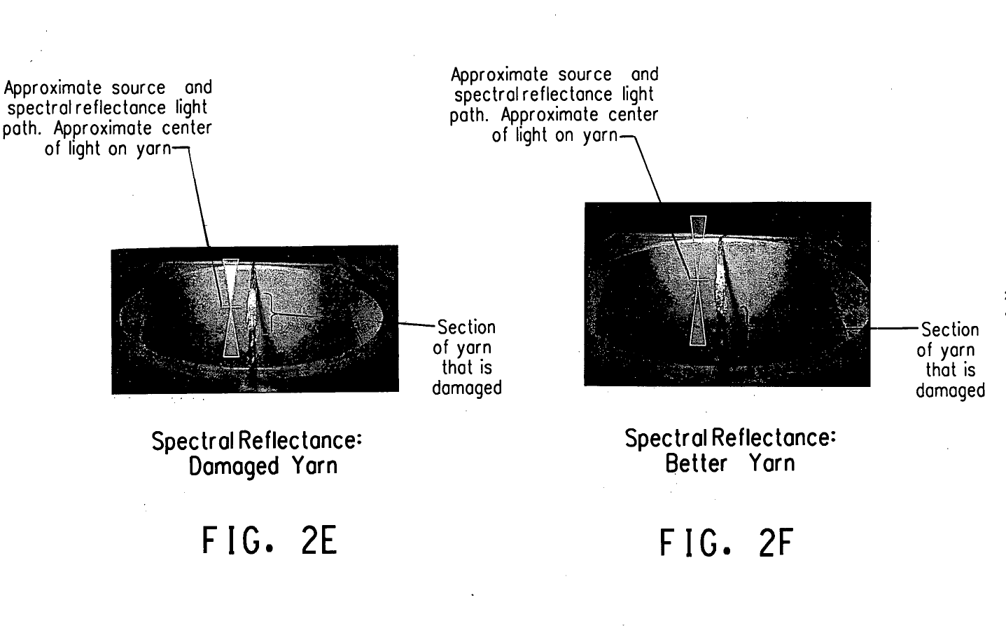

Diffuse reflectance and spectral reflectance was observed for damaged M5® yarn and better M5® yarn under dark and lighted room conditions using an apparatus and method of the invention. FIG. 2 shows the diffuse reflectance of damaged yarn and better yarn in a dark room and the diffuse reflectance of damaged yarn and better yarn in a lighted room. In addition, FIG. 2 shows the spectral reflectance of damaged yarn and better yarn in a dark room.

What is claimed:

1. A process for monitoring the level of surface irregularity in a moving threadline, comprising:
illuminating the threadline via a light source positioned incident to the thread line at an entrance angle of greater than 0 degrees and less than 90 degrees to the threadline to produce spectral reflectance energy and diffuse reflectance energy;
measuring the amount of spectral reflectance energy from the threadline with a first receiver positioned incident to the threadline at an exit angle that is substantially equal to the entrance angle;
measuring the amount of diffuse reflectance energy from the threadline with a second receiver positioned at an angle that is different than the entrance angle and the exit angle,
determining the ratio of the amount of diffuse reflectance energy to the amount of spectral reflectance energy; and
relating said ratio to the level of surface irregularity.

2. The process of claim 1 wherein the second receiver is positioned at an angle of 60 degrees to 120 degrees to the threadline.

3. The process of claim 1, wherein the second receiver is positioned at an angle that is substantially 90 degrees to the threadline.

4. The process of claim 1, wherein the entrance angle is 30 to 60 degrees to the threadline.

5. The process of claim 1, wherein the entrance angle is essentially 45 degrees to the threadline.

6. The process of claim 1, wherein the threadline comprises a rigid rod polymer filament.

7. The process of claim 6, wherein the threadline comprises para-aramid polymer.

8. The process of claim 7, wherein the para-aramid is poly(p-phenylene terephthalamide).

9. The process of claim 6, wherein the threadline comprises a rigid rod polymer filament selected from the group of polybenzazole, polypyridazole, and mixtures thereof.

10. The process of claim 9, wherein the threadline comprises poly[2,6-diimidazo[4,5-b:4,5-e]-pyridinylene-1,4(2,5-dihydroxy)phenylene).

11. The process of claim 1 wherein the threadline is a multifilament threadline.

12. The process of claim 1 wherein the threadline is a monofilament threadline.

13. An apparatus for monitoring the level of surface irregularity in a moving threadline, comprising;
a light source positioned incident to the thread line at an entrance angle of greater than 0 degrees and less than 90 degrees to the threadline, the light source producing spectral reflective energy and diffuse reflective energy;
a first receiver for receiving spectral reflectance energy of the light source from the threadline, the first receiver positioned incident to the threadline at an exit angle substantially equal to the entrance angle;
a second receiver for receiving diffuse reflectance energy of the light source from the threadline, the second receiver positioned incident to the threadline at an angle that is different than the entrance angle and the exit angle; and
a comparator for determining the ratio of the amount of diffuse reflective energy to the amount of spectral reflective energy.

14. The apparatus of claim 13, wherein the second receiver is positioned at an angle of 60 degrees to 120 degrees to the threadline.

15. The apparatus of claim 13, wherein the second receiver is positioned at an angle that is substantially 90 degrees to the threadline.

16. The apparatus of claim 13, wherein the entrance angle is 30 to 60 degrees to the threadline.

17. The apparatus of claim 13, wherein the entrance angle is essentially 45 degrees to the threadline.

18. The apparatus of claim 13, wherein the first and second receivers are positioned at the end of a channel, such that light passes through the channels prior to contacting said detectors.

19. The apparatus of claim 13, wherein said light source is positioned at the end of a channel, such that the light passes through the channel prior to contacting said threadline.

20. The apparatus of claim 13 wherein:
the first and second receivers are positioned at the end of a channel, such that light passes through the channels prior to contacting said detectors;
said light source is positioned at the end of a channel, such that the light passes through the channel prior to contacting said threadline; and
said channels are in communication with a gas purge stream.
